(19) United States
(12) Patent Application Publication
(10) Pub. No.: US 2026/0289210 A1
(43) Pub. Date: Sep. 24, 2026

(54) INFORMATION PROCESSING APPARATUS, INFORMATION PROCESSING METHOD, AND NON-TRANSITORY RECORDING MEDIUM

(71) Applicant: Paru KONDO, Kanagawa (JP)

(72) Inventor: Paru KONDO, Kanagawa (JP)

(21) Appl. No.: 19/567,399

(22) Filed: Mar. 16, 2026

(30) Foreign Application Priority Data
Mar. 18, 2025 (JP) 2025-043267
Jan. 30, 2026 (JP) 2026-014705

(51) Int. Cl. G06K 15/00; B41J 2/21; B41J 3/46

(52) U.S. Cl. CPC G06K 15/407; B41J 2/2121; B41J 3/46; G06K 15/007; G06K 2215/0094; G06K 2215/101

(57) ABSTRACT

An information processing apparatus includes circuitry to estimate, in response to receiving a signal for starting total amount regulation, an ink droplet amount for the time of receiving the signal for starting the total amount regulation, based on a condition that affects a change in the ink droplet amount, convert a tone value of an image to be formed into the ink droplet amount by using the estimated ink droplet amount at the time of receiving the signal for starting the total amount regulation, in a case where the tone value is converted into the ink droplet amount, and perform the total amount regulation to regulate a total ink droplet amount to be used for image formation to a preset value, the total ink droplet amount being the ink droplet converted from the tone value.

### CROSS-REFERENCE TO RELATED APPLICATIONS

This patent application is based on and claims priority pursuant to 35 U.S.C. § 119(a) to Japanese Patent Application Nos. 2025-043267, filed on Mar. 18, 2025, and 2026-014705, filed on Jan. 30, 2026, in the Japan Patent Office, the entire disclosure of which is hereby incorporated by reference herein.

### BACKGROUND

### Technical Field

The present disclosure relates to an information processing apparatus, an information processing method, and a non-transitory recording medium.

### Related Art

As a total amount regulation means for an image forming apparatus such as an inkjet printer, a method has been proposed in which a tone value is converted into an ink droplet amount and then total amount regulation is applied.

### SUMMARY

The present disclosure described herein provides an information processing apparatus including circuitry to estimate, in response to receiving a signal for starting total amount regulation, an ink droplet amount for the time of receiving the signal for starting the total amount regulation, based on a condition that affects a change in the ink droplet amount, convert a tone value of an image to be formed into the ink droplet amount by using the estimated ink droplet amount at the time of receiving the signal for starting the total amount regulation, in a case where the tone value is converted into the ink droplet amount, and perform the total amount regulation to regulate a total ink droplet amount to be used for image formation to a preset value, the total ink droplet amount being the ink droplet converted from the tone value.

The present disclosure described herein provides an information processing method performed by an information processing apparatus, including estimating, in response to receiving a signal for starting total amount regulation, an ink droplet amount for the time of receiving the signal for starting the total amount regulation, based on a condition that affects a change in the ink droplet amount, converting a tone value of an image to be formed into the ink droplet amount by using the estimated ink droplet amount at the time of receiving the signal for starting the total amount regulation, in a case where the tone value is converted into the ink droplet amount, and performing the total amount regulation to regulate a total ink droplet amount to be used for image formation to a preset value, the total ink droplet amount being the ink droplet converted from the tone value.

The present disclosure described herein provides a non-transitory recording medium storing a plurality of instructions which, when executed by one or more processors, causes the one or more processors to perform an information processing method including estimating, in response to receiving a signal for starting total amount regulation, an ink droplet amount for the time of receiving the signal for starting the total amount regulation, based on a condition that affects a change in the ink droplet amount, converting a tone value of an image to be formed into the ink droplet amount by using the estimated ink droplet amount at the time of receiving the signal for starting the total amount regulation, in a case where the tone value is converted into the ink droplet amount, and performing the total amount regulation to regulate a total ink droplet amount to be used for image formation to a preset value, the total ink droplet amount being the ink droplet converted from the tone value.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a graph illustrating the relationship between tone values and ink droplet amounts;

FIG. 2 is a diagram illustrating ink droplet amounts when total amount regulation is performed based on tone values;

FIG. 3 is a diagram illustrating ink droplet amounts when tone values are converted into ink droplet amounts and then total amount regulation is applied;

FIG. 4 is a diagram illustrating a configuration of an image forming system;

FIG. 5 is a diagram illustrating an outline of processing between a host computer and an information processing apparatus in an image forming system;

FIG. 6A is a diagram illustrating a configuration of a color conversion processing unit in an image forming system;

FIG. 6B is a graph illustrating the relation between the ink droplet amount and the tone value;

FIG. 6C is a graph illustrating the relation between the rate of change in the ink droplet amount and the temperature;

FIG. 6D is a graph illustrating the relation between the rate of change in the ink droplet amount and humidity;

FIG. 6E is a graph illustrating the relation between the rate of change in ink droplet amount and the elapsed time;

FIG. 7 is a diagram illustrating a configuration of an ink droplet amount acquisition unit in an image forming system;

FIG. 8 is a diagram illustrating displayed calculation results of estimation accuracy of ink droplet amounts in an image forming system;

FIG. 9A is a diagram illustrating display processing of calculation results of estimation accuracy of ink droplet amounts in an image forming system;

FIG. 9B is a diagram illustrating display processing of calculation results of estimation accuracy of ink droplet amounts in an image forming system;

FIG. 9C is a diagram illustrating display processing of calculation results of estimation accuracy of ink droplet amounts in an image forming system;

FIG. 9D is a diagram illustrating display processing of calculation results of estimation accuracy of ink droplet amounts in an image forming system;

FIG. 9E is a diagram illustrating display processing of calculation results of estimation accuracy of ink droplet amounts in an image forming system;

FIG. 10 is a diagram illustrating a UI in an image forming system;

FIG. 11 is a diagram illustrating a UI in an image forming system;

FIG. 12 is a diagram illustrating a UI in an image forming system; and

FIG. 13 is a diagram illustrating a UI in an image forming system.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing apparatus, an information processing method, a program, and an image forming system will now be described below in detail with reference to the accompanying drawings.

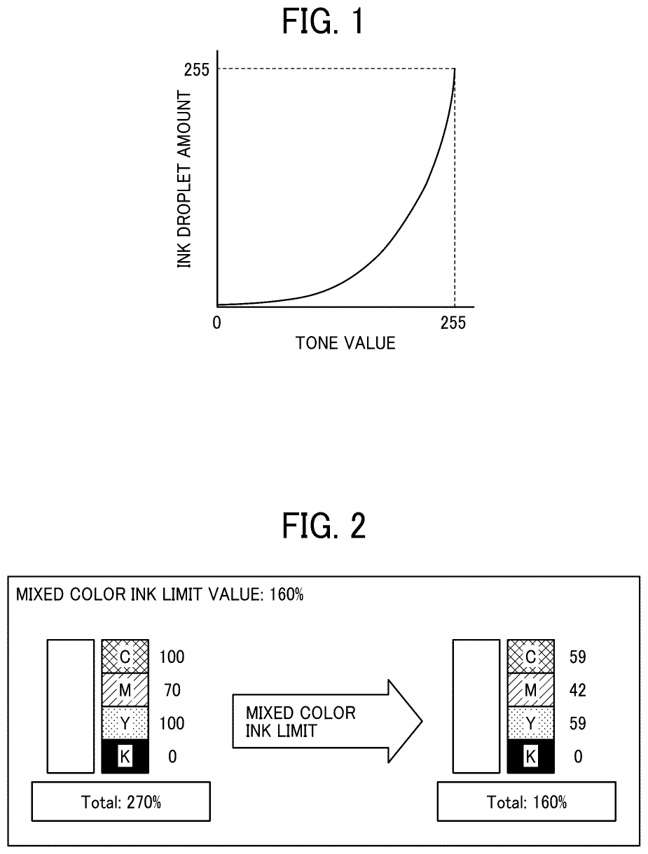

The relationship between tone values and ink droplet amounts will be described with reference to FIG. 1. FIG. 1 is a graph illustrating the relationship between tone values and ink droplet amounts. In FIG. 1, the vertical axis represents ink droplet amounts, and the horizontal axis represents tone values. As illustrated in FIG. 1, the relationship between tone values and ink droplet amounts is not linear. Therefore, when total amount regulation processing is performed based on tone values, the amount of ink ejected becomes smaller than the amount of ink ejected when total amount regulation is performed based on ink droplet amounts. The total amount regulation processing may be processing for limiting the total amount of ink droplet so that the ink droplet amounts do not exceed a predetermined value. In other words, the total amount regulation processing is processing for regulating the total ink droplet amount during image formation to a predetermined value. The tone value may be a numerical value representing the density of the brightness of the color in stages. Further, the ink droplet amount may be a numerical value representing the amount of ink droplets ejected from the nozzles of the inkjet head.

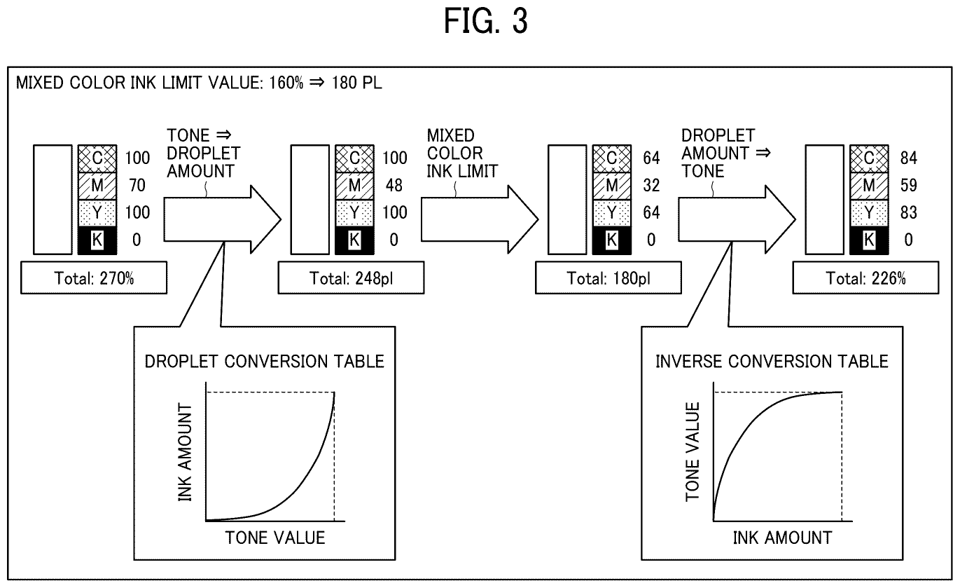

An example of the ink droplet amounts when the total amount regulation is performed based on tone values will be described with reference to FIG. 2. FIG. 2 is a diagram illustrating an example of ink droplet amounts when the total amount regulation is performed based on tone values. When the total amount is regulated by the tone value without conversion by the ink droplet amount (for example, regulating the total amount by setting the mixed-color ink limit value to 160%), as illustrated in FIG. 2, the ink ejection amount becomes smaller than the ink ejection amount when the total amount is regulated by the ink droplet amount. The mixed-color ink limit value is the total value of the ink limit values of the respective CMYK colors. The ink limit value is a ratio of the ink amount with respect to the maximum ink amount (total amount of ink droplets).

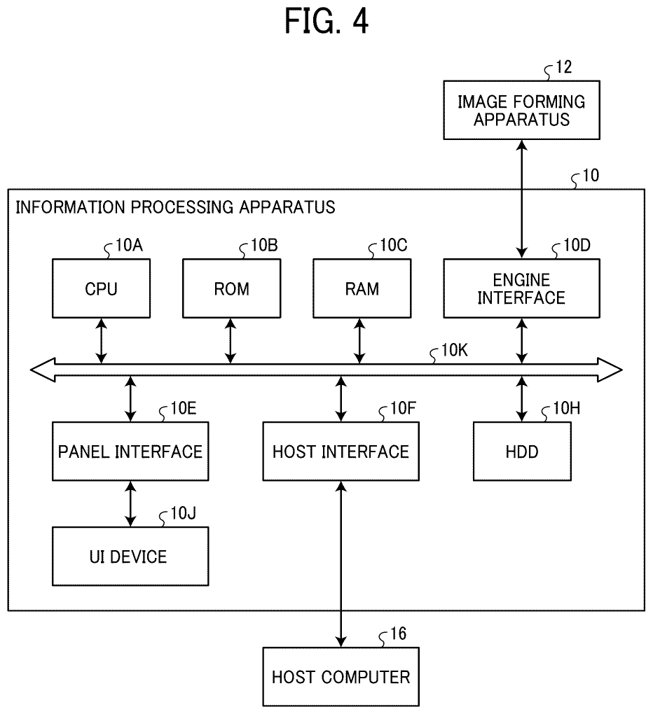

An example of the ink droplet amount when the total amount regulation is applied after the tone value is converted into the ink droplet amount will be described with reference to FIG. 3. FIG. 3 is a diagram illustrating an example of ink droplet amounts when tone values are converted into ink droplet amounts and then the total amount regulation is applied. As illustrated in FIG. 3, it is understood that a larger amount of ink can be ejected when the total amount regulation is applied after conversion into the ink droplet amount, as compared with the case where the total amount is regulated by the tone value. When the ink amount is small, a color reproduction range is narrowed. Accordingly, as illustrated in FIG. 3, the color reproduction range can be expanded to the maximum by performing the total amount regulation (for example, the total amount regulation by setting the ink amount corresponding to a mixed-color ink limit value of 160% to 180 pl) after the conversion into the ink droplet amount.

In the related art, the tone value can be converted into the ink droplet amount by using a table representing a relationship between the tone value and the ink droplet amount stored in advance. A method of converting the tone value into the ink droplet amount using a look-up table (LUT) has been proposed. In both cases, the tone value is converted into the ink droplet amount based on a predetermined fixed value. However, the ink droplet amount with respect to the tone value is not necessarily constant due to, for example, the environment such as temperature, humidity, and atmospheric pressure, the manufacturing variation and the over-time change of the nozzle of the inkjet head. In the case of the predetermined fixed value, the fixed value cannot be handled, and a difference from the actual ink amount occurs.

The difference between the ink droplet amount of the LUT and the actual ink amount is directly related to the image quality in the total amount regulation. The smaller the difference between the ink droplet amount and the actual ink amount, the more the color reproduction range can be expanded to the maximum, and therefore the image quality is enhanced. When the ink droplet amount is smaller than the actual ink amount, the color reproduction range is reduced due to the total ink amount being excessively regulated. When the actual ink amount is larger than the ink droplet amount, the ink excessively adheres to the paper, and the paper is conveyed while the ink is not dried, which causes a failure of the printer or deterioration of image quality due to bleeding or show-through. In the related art, since the accuracy of the ink droplet amount (difference between the ink droplet amount and the actual ink amount) is insufficient, the image quality is deteriorated.

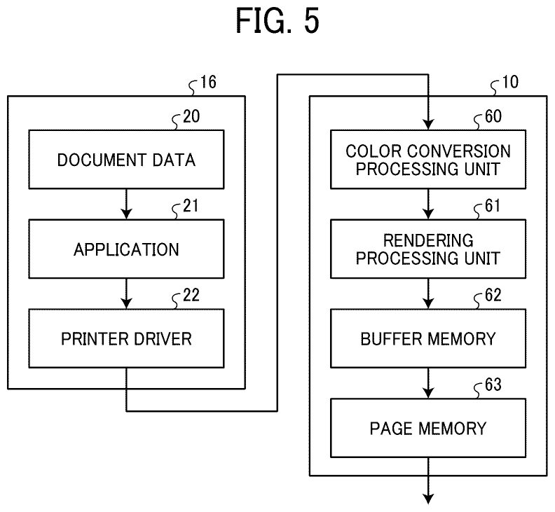

The configuration of the image forming system will be described in detail with reference to FIG. 4. FIG. 4 is a diagram illustrating the configuration of the image forming system.

As illustrated in FIG. 4, the image forming system includes an information processing apparatus 10, an image forming apparatus 12, and a host computer 16. The host computer 16 and the image forming apparatus 12 are communicably connected to the information processing apparatus 10.

The information processing apparatus 10 receives a drawing command for rendering printing data from the host computer 16, performs conversion processing of the printing data into a format that can be processed by the image forming apparatus 12, and outputs print data, which is the printing data after the conversion processing, to the image forming apparatus 12. A plurality of image forming apparatuses 12 may be connected to the information processing apparatus 10. Alternatively, the image forming apparatus 12 may be directly connected to the host computer 16 without the information processing apparatus 10.

The information processing apparatus 10 includes a central processing unit (CPU) 10A, a read-only memory (ROM) 10B, a random-access memory (RAM) 10C, an engine interface 10D, a panel interface 10E, a host interface 10F, a hard disk drive (HDD) 10H, and a user interface (UI) device. The CPU 10A executes a control program stored in a storage device such as ROM 10B, RAM 10C, and HDD 10H and controls the overall operation of the information processing apparatus 10.

Examples of the storage device include the ROM 10B, the RAM 10C, and the HDD 10H. The ROM 10B stores a fixed program. The RAM 10C has a storage area as a work area of the CPU 10A. The HDD 10H stores, for example, various control programs, measured values, and conversion tables.

The panel interface 10E is a connection interface to be connected with the UI device 10J. The panel interface 10E displays a screen instructed by the CPU 10A on the UI device 10J, and transmits an operation command received by the UI device 10J to the CPU 10A. The UI device 10J includes a display unit for a setting screen for performing various settings of the image forming apparatus 12, and an entry reception unit for receiving various setting inputs from a user.

The host interface 10F is connected to the host computer 16 for communication, and receives a drawing command from the host computer 16. The engine interface 10D outputs the converted print data to the image forming apparatus 12 based on an outputting instruction from the CPU 10A.

The image forming apparatus 12 includes an image forming unit. The image forming apparatus 12 includes, for example, an image forming unit of an electronic photography type or an inkjet type. The image forming apparatus 12 forms an image on a medium by the image forming unit using the print data generated by the information processing apparatus 10.

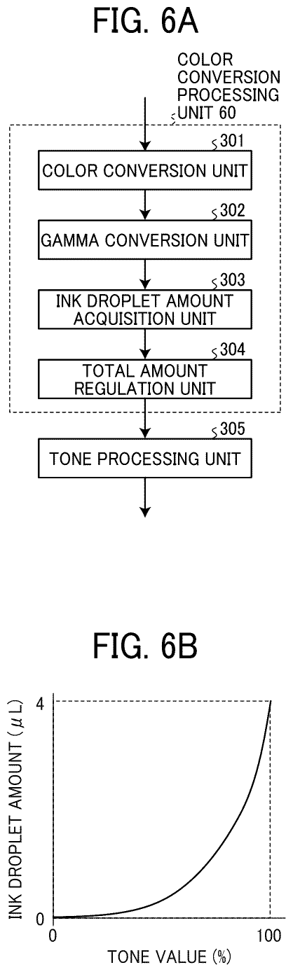

An outline of processing performed by the host computer 16 and the information processing apparatus 10 in the image forming system will be described with reference to FIG. 5. FIG. 5 is a diagram illustrating an example of the outline of processing performed by the host computer 16 and the information processing apparatus 10 in the image forming system. The host computer 16 is installed with various applications 21 that generate, for example, document data 20. When the host computer 16 receives an instruction to execute a printing process of the document data 20 generated by the application 21 from the user, the host computer 16 performs a desired process by a printer driver 22 and outputs a drawing command.

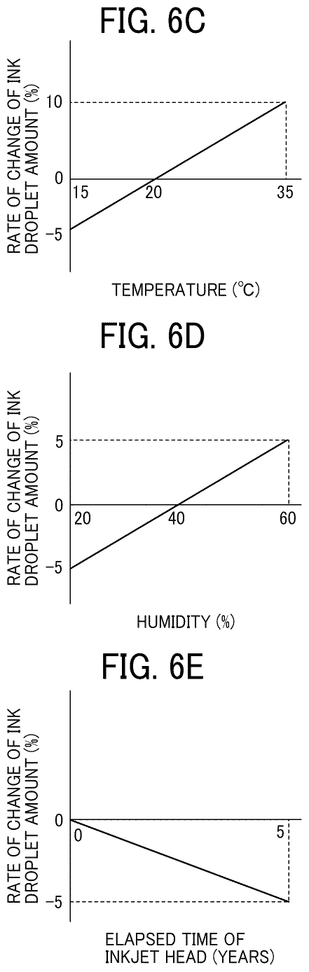

The information processing apparatus 10 converts the drawing command received from the host computer 16 into print data that can be processed by the image forming apparatus 12. Details of the color conversion processing unit 60 are illustrated in FIG. 6 described below. A rendering processing unit 61 converts the print data in the command format into image data in a raster format, and stores the image data in the buffer memory 62. The image data in the raster format stored in the buffer memory 62 is output as the print data from the page memory 63.

An example of the configuration of the color conversion processing unit 60 in the image forming system will be described with reference to FIGS. 6A to 6E. FIG. 6A is a diagram illustrating the configuration of the color conversion processing unit 60 in the image forming system. FIGS. 6B to 6E are graphs for describing the processing of estimating the ink droplet amount in the image forming system. In FIG. 6B, a vertical axis represents the ink droplet amount (μl), and a horizontal axis represents the tone values (%).

In FIG. 6C to 6E, the vertical axis represents the rate of change of the ink droplet amount (%). The horizontal axis in FIG. 6C represents temperature (degrees). The horizontal axis in FIG. 6D represents humidity (%). The horizontal axis in FIG. 6E represents the elapsed time of the inkjet head (years). As illustrated in FIG. 6A, the color conversion processing unit 60 includes a color conversion unit 301, a γ conversion unit 302, an ink droplet amount acquisition unit 303, and a total amount regulation unit 304.

The color conversion unit 301 performs color conversion processing on color data of a drawing command received from the host computer 16. The γ conversion unit 302 performs γ conversion processing on the color data on which the color conversion processing has been performed by the color conversion unit 301.

The ink droplet amount acquisition unit 303 is an example of an estimation unit (calculation unit) that estimates (calculates) the ink droplet amount at the time of receiving the total amount regulation start signal based on conditions (for example, environment and engine state) that affect the change in the ink droplet amount after receiving the total amount regulation start signal. Specifically, the ink droplet amount acquisition unit 303 accurately estimates the ink droplet amount when the signal for starting the total amount regulation is received, based on the measurement value data of the ink droplet amount accumulated in the past and the state of the engine at that time. The engine state at that time is, for example, the environment such as the temperature and humidity inside the image forming apparatus 12 (particularly, the environment such as the temperature and humidity around the inkjet head mounted on the image forming apparatus 12), the environment such as the temperature and humidity outside the image forming apparatus 12, and the deterioration state of the inkjet head. Accordingly, the time required for acquiring the ink droplet amount and the consumption amount of ink can be significantly reduced while maintaining the estimation accuracy of the ink droplet amount at the same level as that when the ink droplet amount is actually measured. The signal for starting the total amount regulation received by the ink droplet amount acquisition unit 303 may be a signal from the image forming apparatus 12, may be a signal from the host computer 16, or may be an operation command received by the UI device 10J. The ink droplet amount acquisition unit 303 is started when a signal for starting the total amount regulation is received. For example, the ink droplet amount (μl) when the temperature is 20° C., the relative humidity is 40%, and the elapsed time of the inkjet head is 0 year is the measurement value illustrated in FIG. 6B.

In addition, the temperature, the humidity, and the rate of change (%) in the ink droplet amount for each elapsed time of the inkjet head are illustrated in FIGS. 6C to 6E. These are data analyzed from the accumulation of past engine states and measurement data. When the signal for starting the total amount regulation is received, in a case where the temperature is 15° C., the humidity is 60%, and the elapsed time of the inkjet head is 5 years, the ink droplet amount acquisition unit 303 estimates the ink droplet amount of the tone value of 100% by the following Equation (1).

Ink droplet amount in which the tone values illustrated in FIG. 6B is 100%×(1+rate of change in the ink droplet amount [temperature])×(1+rate of change the ink droplet amount [humidity])×(1+rate of change in the ink droplet amount [elapsed time of the inkjet head])=4×(1−0.05)×(1+0.05)×(1−0.05)=3.8 . . . (1)

The conditions that affect the change in the ink droplet amount may be conditions other than the three conditions, in other words, the temperature, the humidity, and the elapsed time of the inkjet head. The estimation of the ink droplet amount by the ink droplet amount acquisition unit 303 is also preferably performed using the three conditions in other words, the temperature, the humidity, and the inkjet head. However, all of the three conditions, in other words, the temperature, the humidity, and the inkjet head, may not be used. For example, when the signal for starting the total amount regulation is received, when the temperature is 15° C., the ink droplet amount acquisition unit 303 may estimate the ink droplet amount of the tone value of 100% by the following formula (2).

Ink droplet amount in which the tone values illustrated in FIG. 6B is 100%×(1+rate of change in the ink droplet amount [temperature])=4×(1−0.05)=3.9 . . . (2)

The temperature and humidity in Equation (1) and Equation (2) may be the temperature and humidity inside the image forming apparatus 12 or the temperature and humidity outside the image forming apparatus 12.

The total amount regulation unit 304 is an example of a total amount regulation unit that performs the total amount regulation using the ink droplet amount at the time of receiving the signal for starting the total amount regulation calculated by the ink droplet amount acquisition unit 303 when the tone value is converted into the ink droplet amount. Specifically, the tone processing unit 305 is an example of a tone processing unit that converts the tone value into the ink droplet amount using the ink droplet amount at the time of receiving the signal for starting the total amount regulation, which is estimated by the ink droplet amount acquisition unit 303, when the tone value of the image to be formed is converted into the ink droplet amount. The total amount regulation unit 304 performs the total amount regulation to regulate the total amount of ink droplets converted from the tone value to a predetermined value.

The tone processing unit 305 converts the ink droplet amount subjected to the total amount regulation into the tone value. The tone processing unit 305 is an example of a tone processing unit that converts the tone value into the ink droplet amount using a conversion table for converting the tone value into the estimated ink droplet amount and an inverse conversion table for converting an estimated ink droplet amount into the tone value. The tone processing unit 305 is provided outside the color conversion processing unit 60, but may be provided inside the color conversion processing unit 60.

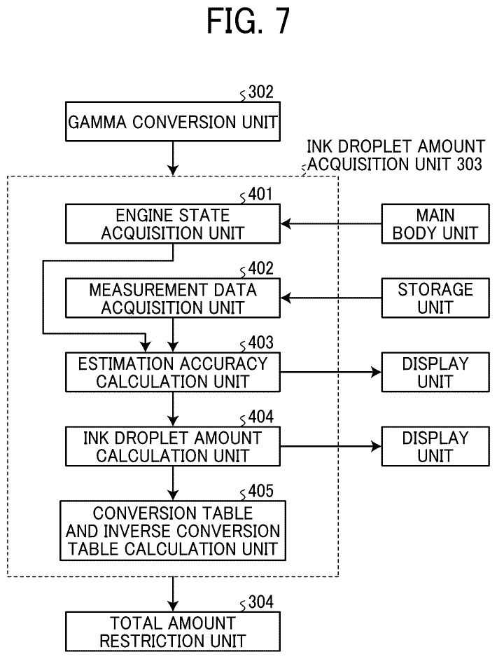

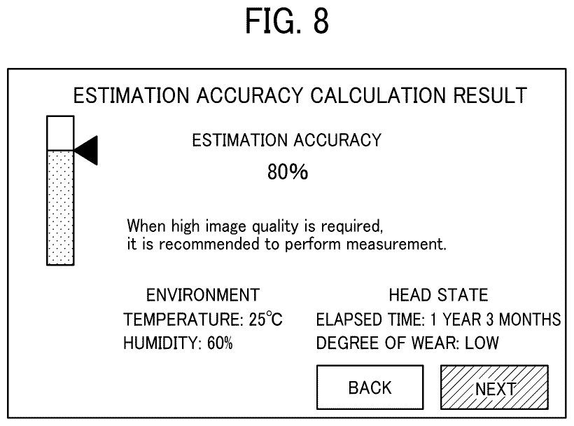

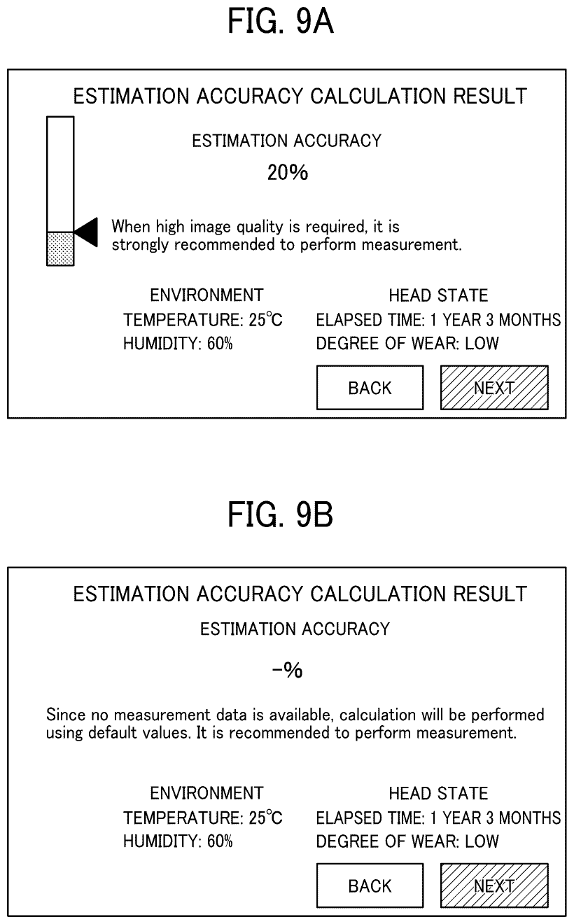

The configuration of the ink droplet amount acquisition unit 303 in the image forming system will be described with reference to FIGS. 7, 8, and 9A to 9E. FIG. 7 is a diagram illustrating the configuration of the ink droplet amount acquisition unit 303 in the image forming system. FIG. 8 and FIG. 9A to FIG. 9E are diagrams illustrating displayed calculation results of estimation accuracy of the ink droplet amounts in the image forming system. As illustrated in FIG. 7, the ink droplet amount acquisition unit 303 includes an engine state acquisition unit 401, a measurement data acquisition unit 402, an estimation accuracy calculation unit 403, an ink droplet amount calculation unit 404, and a conversion table and inverse conversion table calculation unit 405.

The engine state acquisition unit 401 acquires the engine state from the main body. For example, the engine state is information that affects the change in the ink droplet amount, such as an environment such as a temperature and humidity around the inkjet head, and the elapsed years and the degree of deterioration of the inkjet head.

The measurement data acquisition unit 402 acquires the measurement value data of the accumulated ink droplet amount from the storage device. Examples of the measurement value data include data measured by this machine (in other words, the image forming apparatus 12) in the past and data measured by another machine. Each piece of measurement value data is also associated with data of an engine state and a type of paper (paper type).

The estimation accuracy calculation unit 403 calculates the estimation accuracy of the ink droplet amount based on the engine state acquired by the engine state acquisition unit 401 and the measurement value data obtained from the measurement data acquisition unit 402. For example, the estimation accuracy calculation unit 403 may calculate the estimation accuracy of the ink droplet amount using artificial intelligence (AI). The estimation accuracy of the ink droplet amount changes depending on whether there is data in which the engine state associated with the measurement value data is close to the engine state when the signal for starting the total amount regulation is received, or whether the measurement value data is sufficiently prepared in the first place.

The estimation accuracy calculation unit 403 is an example of a display control unit that displays the calculation result of the estimation accuracy of the ink droplet amount on the display unit of the UI device 10J as illustrated in FIGS. 8 and 9A. The estimation accuracy calculation unit 403 may display, for example, a message for prompting the measurement of the ink droplet amount as illustrated in FIGS. 8 and 9A depending on the numerical value of the estimation accuracy of the ink droplet amount. In other words, the estimation accuracy calculation unit 403 displays a message serving as a guide for subsequent action determination on the display unit based on the calculation result of the estimation accuracy of the ink droplet amount.

As illustrated in FIGS. 8 and 9A, the estimation accuracy calculation unit 403 may change the color of the character depending on the numerical value of the estimation accuracy of the ink droplet amount. In other words, the estimation accuracy calculation unit 403 displays the numerical value of the estimation accuracy of the ink droplet amount on the display unit by changing the decoration of the characters according to the magnitude of the numerical value. The estimation accuracy calculation unit 403 may display a bar as illustrated in FIGS. 8 and 9A so that the magnitude of the estimation accuracy of the ink droplet amount can be visually recognized. In other words, the estimation accuracy calculation unit 403 displays the magnitude of the numerical value of the estimation accuracy of the ink droplet amount on the display unit in a figure.

The ink droplet amount calculation unit 404 is an example of a display control unit that calculates (estimates) the ink droplet amount with a default value at the time of factory shipment and displays on the display unit that the ink droplet amount has been calculated with the default value in a case where there is no data necessary for the calculation of the ink droplet amount when a signal for starting the total amount regulation is received immediately after, for example, the factory shipment. For example, the ink droplet amount calculation unit 404 may estimate the ink droplet amount when the signal for starting the total amount regulation is received by the AI. When there is no data necessary for calculating the ink droplet amount immediately after, for example, the factory shipment, the ink droplet amount calculation unit 404 displays a message prompting the measurement of the ink droplet amount on the display unit as illustrated in FIG. 9B. When there is measurement value data that is measured by another machine and that is of the same paper type, the ink droplet amount calculation unit 404 may receive a selection indicating whether to calculate the ink droplet amount using the measurement value data, as illustrated in FIG. 9C In other words, when there is no measurement value data necessary for estimating the ink droplet amount, the ink droplet amount calculation unit 404 receives a selection indicating whether to use the measurement value data of the other machine. When the use of the measurement value data of the other machine is selected, the ink droplet amount calculation unit 404 estimates the ink droplet amount when the signal for starting the total amount regulation is received, using the measurement value data of the other machine.

When the thermometer or the hygrometer is broken and measurement value data such as environmental information such as temperature and humidity cannot be acquired, the engine state including a state (for example, the number of elapsed years and a deterioration degree) of the inkjet head cannot be acquired due to some malfunction. In this case, as illustrated in FIG. 9D, the ink droplet amount calculation unit 404 may receive the selection of the closest environmental information and the state of the inkjet head by the user. The environmental information and the state of the inkjet head are not essential information for the calculation of the ink droplet amount. However, the more information useful for the calculation of the ink droplet amount and the more accurate, the higher the estimation accuracy of the ink droplet amount. In other words, when the condition (for example, environmental information or the engine state) that affects the change in the ink droplet amount cannot be acquired, the ink droplet amount calculation unit 404 receives selection of the condition that affects the change in the ink droplet amount via the UI device 10J (an example of an operation unit), and estimates the ink droplet amount when the signal for starting the total amount regulation is received based on the received condition.

When the environmental information and the state of the inkjet head are inappropriate, the ink droplet amount calculation unit 404 may display a message indicating the inappropriate state on the display unit. For example, when the environmental information is outside the guarantee range of the machine, the ink droplet amount calculation unit 404 may display a message indicating that the environmental information is outside the guarantee range of the machine. Additionally, when the number of the elapsed years of the inkjet head has exceeded, the ink droplet amount calculation unit 404 may display a message suggesting head replacement on the display unit as illustrated in FIG. 9E. In other words, when the condition (for example, the environmental information or the engine state) affecting the change of the ink droplet amount is inappropriate, the ink droplet amount calculation unit 404 displays the fact on the display unit.

The ink droplet amount calculation unit 404 displays a change in the ink droplet amount (ink change amount) before and after the calculation (estimation) on the display unit. The ink droplet amount calculation unit 404 displays a change in the ink droplet amount before and after the calculation on the display unit together with the past ink droplet amount. Additionally, the ink droplet amount calculation unit 404 simulates changes in the color reproduction range and the ink droplet amount due to changes in the environment and the engine state, and displays the simulated changes on the display unit.

The conversion table and inverse conversion table calculation unit 405 calculates a conversion table for converting the tone value into the ink amount and an inverse conversion table for converting the ink amount into the tone value. The conversion table and inverse conversion table are used in the tone processing unit 305.

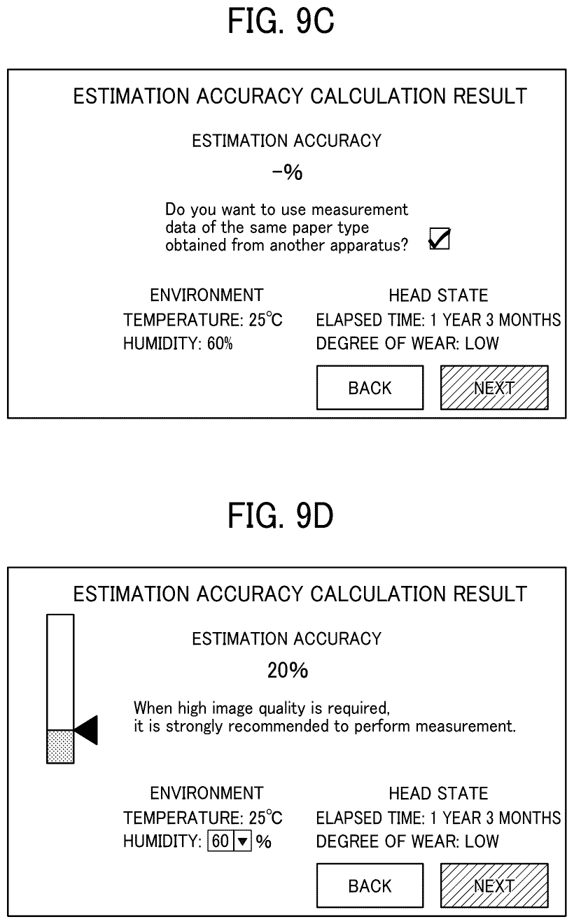

An example of a UI in the image forming system will be described with reference to FIGS. 10 to 13. FIGS. 10 to 13 are diagrams illustrating examples of UIs in the image forming system. When the measurement value data (ink droplet amount) does not exist immediately after, for example, the factory shipment, the ink droplet amount calculation unit 404 may use the measurement value data set as a default at the time of the factory shipment, and display on the display unit that the default value has been used for calculation of the estimation accuracy of the ink droplet amount, as illustrated in FIG. 10. As illustrated in FIG. 10, the ink droplet amount calculation unit 404 may display, for example, a message prompting the measurement of the ink droplet amount on the display unit because there is no measurement value data.

The ink droplet amount calculation unit 404 calculates the ink droplet amounts at the time of receiving the signal for starting the total amount regulation based on the engine state acquired by the engine state acquisition unit 401 and the measurement value data acquired by the measurement data acquisition unit 402. The ink droplet amount calculation unit 404 analyzes a change tendency of the ink droplet amount due to the environment and the engine state based on the measurement value data acquired by the measurement data acquisition unit 402. The ink droplet amount calculation unit 404 calculates the ink droplet amount at the time of receiving the signal for starting the total amount regulation based on the engine state acquired by the engine state acquisition unit 401 and the analysis result. For example, machine learning may be used for the analysis and calculation of the engine state.

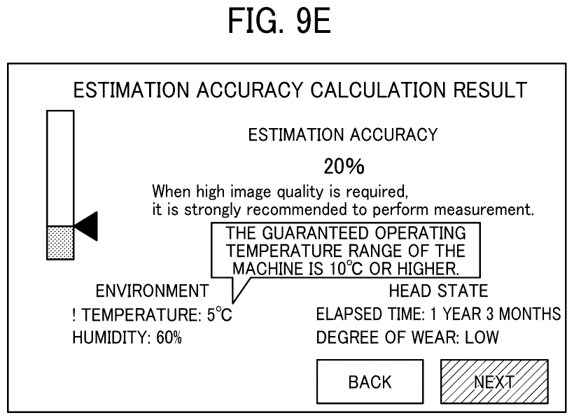

As illustrated in FIG. 11, the ink droplet amount calculation unit 404 displays the ink change amount of the ink droplet amount before and after the calculation on the display unit. The user can confirm that the color reproduction range is maintained by viewing the ink change amount of the ink droplet amount before and after the calculation.

As illustrated in FIG. 11, the ink droplet amount calculation unit 404 may display the engine state (for example, an environment such as temperature and humidity, and a deterioration degree of the inkjet head) acquired by the engine state acquisition unit 401. The user can confirm whether the environment needs to be enhanced by knowing the environment and the engine state.

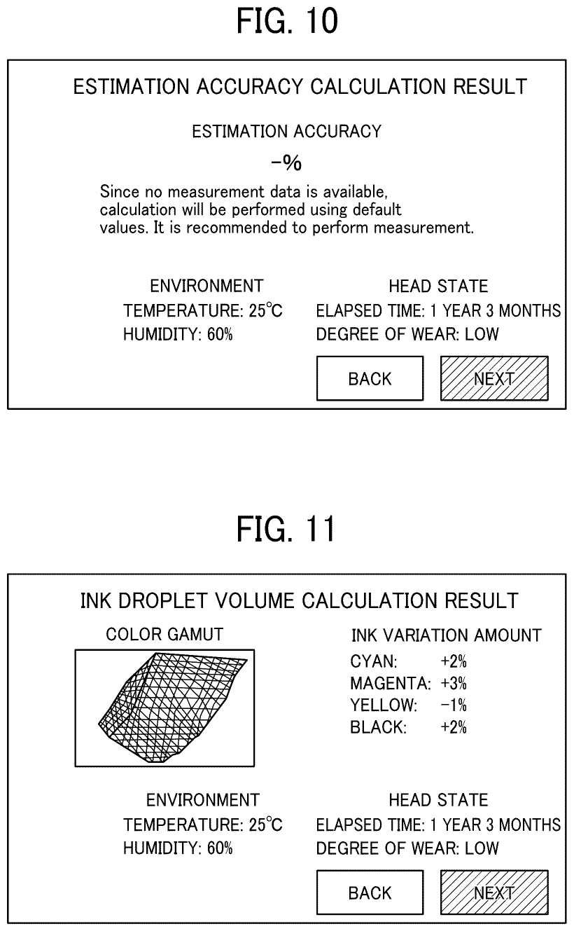

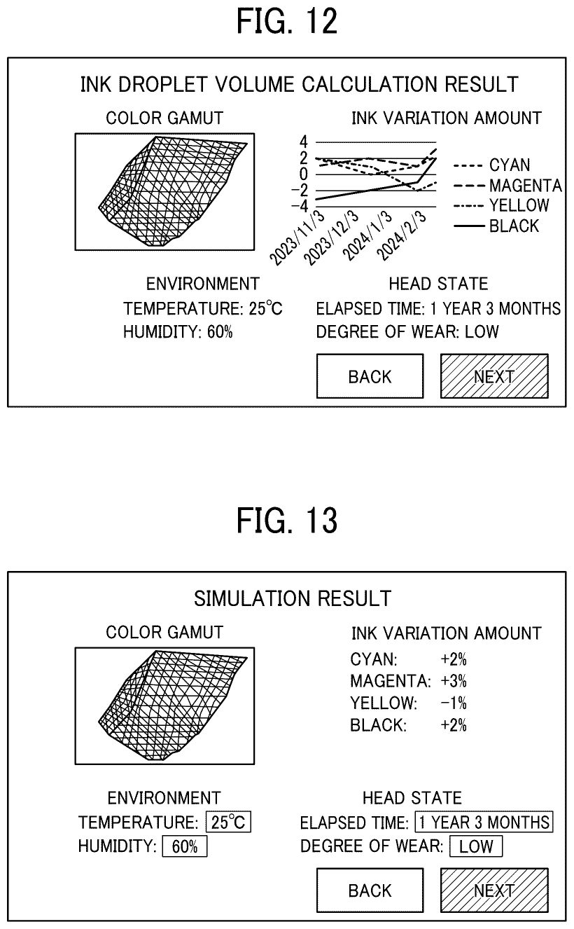

As illustrated in FIG. 12, the ink droplet amount calculation unit 404 may display the ink change amount together with the past ink change amount in a graph. As illustrated in FIG. 13, the ink droplet amount calculation unit 404 may simulate the color gamut and the ink change amount by changing the environment and the head state.

As described above, the information processing apparatus 10 significantly reduces the time required to acquire the ink droplet amount and the ink consumption amount and enhances the image quality to the maximum while maintaining the estimation accuracy of the ink droplet amount at the same level as that when the ink droplet amount is actually measured.

The program executed by the information processing apparatus 10 is installed in, for example, the ROM 10B in advance. The program executed by the information processing apparatus 10 according to the present embodiment may be stored in any computer-readable recording medium, such as a compact disc read-only memory (CD-ROM), a flexible disk (FD), a compact disc-recordable (CD-R), or a digital versatile disc (DVD), in an installable or executable file format and provided as a computer program product.

Additionally, the computer programs executed in the information processing apparatus 10 may be stored in a computer connected to a network such as the Internet and downloaded through the network. Alternatively, the computer programs executed in the information processing apparatus 10 may be provided or distributed via a network such as the Internet.

The program to be executed by the information processing apparatus 10 is in a modular configuration including various units such as the color conversion processing unit 60 and the tone processing unit 305. As hardware, the CPU 10A, which is an example of a processor, reads the program from the ROM 10B and executes the program. In this execution, for example, the color conversion processing unit 60 and the tone processing unit 305 are loaded and implemented in a main memory.

Aspects of the present disclosure are, for example, as follows.

### Aspect 1

An information processing apparatus includes an estimation unit that estimates, after receiving a signal for starting total amount regulation that regulates total ink droplet amount at the time of image formation to a preset value, the ink droplet amount at the time of receiving the signal for starting the total amount regulation, based on a condition that affects a change in the ink droplet amount;
a tone processing unit that converts a tone value of an image to be formed into the ink droplet amount by using the ink droplet amount at the time of receiving the signal for starting the total amount regulation estimated by the estimation unit, when the tone value is converted into the ink droplet amount; and
a total amount regulation unit that performs the total amount regulation to regulate the total ink droplet amount converted from the tone value to the preset value.

### Aspect 2

In the information processing apparatus according to Aspect 1, the tone processing unit converts the tone value into the ink droplet amount using a table for converting the tone value into the estimated ink droplet amount and a table for converting the estimated ink droplet amount into the tone value.

### Aspect 3

The information processing apparatus according to Aspect 1 or 2 further includes a display control unit that displays, on a display unit, a calculation result of estimation accuracy of the ink droplet amount when the signal for starting the total amount regulation is received by the estimation unit.

### Aspect 4

In the information processing apparatus according to Aspect 3, the display control unit displays, on the display unit, a numerical value of the estimation accuracy of the ink droplet amount when the signal for starting the total amount regulation is received by the estimation unit, by changing decoration of characters depending on a magnitude of the numerical value.

### Aspect 5

In the information processing apparatus according to Aspect 3 or 4, the display control unit displays, on the display unit, a magnitude of a numerical value of the estimation accuracy of the ink droplet amount by a figure when the signal for starting the total amount regulation is received by the estimation unit.

### Aspect 6

In the information processing apparatus according to any one of Aspects 3 to 5, the display control unit displays a message serving as a guide for subsequent action determination on the display unit based on a calculation result of estimation accuracy of the ink droplet amount when the signal for starting the total amount regulation is received by the estimation unit.

### Aspect 7

In the information processing apparatus according to any one of Aspects 3 to 6, the estimation unit estimates the ink droplet amount with a default value at the time of factory shipment when there is no data necessary for estimating the ink droplet amount when the signal for starting the total amount regulation is received, and
the display control unit displays, on the display unit, a message indicating that the ink droplet amount has been estimated with the default value.

### Aspect 8

In the information processing apparatus according to any one of Aspects 3 to 7, the display control unit displays a message prompting measurement of the ink droplet amount on the display unit when there is no data necessary for estimating the ink droplet amount when the signal for starting the total amount regulation is received by the estimation unit.

### Aspect 9

In the information processing apparatus according to any one of Aspects 3 to 8, the display control unit displays, on the display unit, a change in the ink droplet amount when the signal for starting the total amount regulation is received before and after the estimation by the estimation unit.

### Aspect 10

In the information processing apparatus according to any one of Aspects 3 to 9, the display control unit displays, on the display unit, a change in the ink droplet amount when the signal for starting the total amount regulation is received before and after the estimation by the estimation unit, together with the ink droplet amount in the past.

### Aspect 11

In the information processing apparatus according to any one of Aspects 3 to 10, the display control unit simulates a change in the color reproduction range and the ink droplet amount due to a change in an environment and an engine state and displays the change on the display unit.

### Aspect 12

In the information processing apparatus according to any one of Aspects 1 to 11, the estimation unit receives a selection indicating whether to use measurement value data of another machine when there is no data necessary for estimating the ink droplet amount, and estimates the ink droplet amount at the time of receiving the signal for starting the total amount regulation using the measurement value data of the another machine when the use of the measurement value data of the another machine is selected.

### Aspect 13

In the information processing apparatus according to any one of Aspects 1 to 12, when the condition that affects the change of the ink droplet amount is not acquired, the estimation unit receives selection of the condition that affects the change of the ink droplet amount via an operation unit, and estimates the ink droplet amount at the time of receiving the signal for starting the total amount regulation based on the received condition.

### Aspect 14

In the information processing apparatus according to any one of Aspects 3 to 11, when the condition affecting the change of the ink droplet amount is inappropriate, the display control unit displays the fact on the display unit.

### Aspect 15

In the information processing apparatus according to any one of Aspects 3 to 11, the estimation unit estimates the ink droplet amount when the signal for starting the total amount regulation is received and calculates estimation accuracy of the ink droplet amount by AI.

### Aspect 16

An information processing method performed by an information processing apparatus, comprising:
estimating, after receiving a signal for starting total amount regulation that regulates total ink droplet amount at the time of image formation to a preset value, the ink droplet amount at the time of receiving the signal for starting the total amount regulation, based on a condition that affects a change in the ink droplet amount;
converting a tone value of an image to be formed into the ink droplet amount by using the estimated ink droplet amount at the time of receiving the signal for starting the total amount regulation, when the tone value is converted into the ink droplet amount; and
performing the total amount regulation to regulate the total ink droplet amount converted from the tone value to the preset value.

### Aspect 17

A program causes a computer to function as: an estimation unit that estimates, after receiving a signal for starting total amount regulation that regulates total ink droplet amount at the time of image formation to a preset value, the ink droplet amount at the time of receiving the signal for starting the total amount regulation, based on a condition that affects a variation in the ink droplet amount;
a tone processing unit that converts a tone value of an image to be formed into the ink droplet amount by using the ink droplet amount at the time of receiving the signal for starting the total amount regulation estimated by the estimation unit, when the tone value is converted into the ink droplet amount; and
a total amount regulation unit that performs the total amount regulation to regulate the total ink droplet amount converted from the tone value to the preset value.

### Aspect 18

A program causes a computer to function as: an estimation unit that estimates, after receiving a signal for starting total amount regulation that regulates total ink droplet amount at the time of image formation to a preset value, the ink droplet amount at the time of receiving the signal for starting the total amount regulation, based on a condition that affects a variation in the ink droplet amount;
a tone processing unit that converts a tone value of an image to be formed into the ink droplet amount by using the ink droplet amount at the time of receiving the signal for starting the total amount regulation estimated by the estimation unit, when the tone value is converted into the ink droplet amount; and
a total amount regulation unit that performs the total amount regulation to regulate the total ink droplet amount converted from the tone value to the preset value.

In the related art, since the conversion into the ink droplet amount is performed using a fixed LUT, an error occurs with respect to the actual ink droplet amount. As the error increases, the color reproduction range cannot be widened to the maximum, and the image quality decreases.

According to the present disclosure, an effect of enhancing image quality is achieved.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing apparatus comprising circuitry configured to:
estimate, in response to receiving a signal for starting total amount regulation, an ink droplet amount for the time of receiving the signal for starting the total amount regulation, based on a condition that affects a change in the ink droplet amount;
convert a tone value of an image to be formed into the ink droplet amount by using the estimated ink droplet amount at the time of receiving the signal for starting the total amount regulation, in a case where the tone value is converted into the ink droplet amount; and
perform the total amount regulation to regulate a total ink droplet amount to be used for image formation to a preset value, the total ink droplet amount being the ink droplet converted from the tone value.

2. The information processing apparatus according to claim 1,
wherein the circuitry is configured to convert the tone value into the ink droplet amount using a table for converting the tone value into the estimated ink droplet amount and a table for converting the estimated ink droplet amount into the tone value.

3. The information processing apparatus according to claim 1,
wherein the circuitry is configured to display, on a display, a calculation result of estimation accuracy of the estimated ink droplet amount.

4. The information processing apparatus according to claim 3,
wherein the circuitry is configured to change decoration of characters according to a magnitude of a numerical value of the estimation accuracy of the estimated ink droplet amount, and display, on the display, the numerical value of the estimation accuracy of the estimated ink droplet amount.

5. The information processing apparatus according to claim 3,
wherein the circuitry is configured to display, on the display, a magnitude of a numerical value of the estimation accuracy of the estimated ink droplet amount in the form of a figure.

6. The information processing apparatus according to claim 3,
wherein the circuitry is configured to display a message serving as a guide for determining a subsequent action on the display based on a calculation result of the estimation accuracy of the estimated ink droplet amount.

7. The information processing apparatus according to claim 3,
wherein the circuitry is configured to estimate the ink droplet amount with a default value at the time of factory shipment when there is no data used for estimating the ink droplet amount for the time of receiving the signal for starting the total amount regulation, and
wherein the circuitry is configured to display, on the display, a message indicating that the ink droplet amount has been estimated with the default value.

8. The information processing apparatus according to claim 3,
wherein the circuitry is configured to display a message prompting measurement of the ink droplet amount on the display when there is no data used for estimating the ink droplet amount for the time of receiving the signal for starting the total amount regulation.

9. The information processing apparatus according to claim 3,
wherein the circuitry is configured to display, on the display, a change in the estimated ink droplet amount for the time of receiving the signal for starting the total amount regulation before and after the estimation.

10. The information processing apparatus according to claim 3,
wherein the circuitry is configured to display, on the display, a change in the ink droplet amount for the time of receiving the signal for starting the total amount regulation before and after the estimation, together with the ink droplet amount obtained in the past.

11. The information processing apparatus according to claim 3,
wherein the circuitry is configured to simulate a change in a color reproduction range and the ink droplet amount due to a change in an environment and an engine state and displays the simulated change on the display.

12. The information processing apparatus according to claim 1,
wherein the circuitry is configured to receive a selection indicating whether to use measurement value data of another machine when there is no data used for estimating the ink droplet amount, and estimate the ink droplet amount for the time of receiving the signal for starting the total amount regulation using the measurement value data of said another machine when the use of the measurement value data of the another machine is selected.

13. The information processing apparatus according to claim 1,
wherein the circuitry is configured to, when the condition that affects the change of the ink droplet amount is not acquired, receive a selection of the condition that affects the change of the ink droplet amount via an operation device, and estimate the ink droplet amount for the time of receiving the signal for starting the total amount regulation based on the received condition.

14. An information processing method performed by an information processing apparatus, comprising:
estimating, in response to receiving a signal for starting total amount regulation, an ink droplet amount for the time of receiving the signal for starting the total amount regulation, based on a condition that affects a change in the ink droplet amount;
converting a tone value of an image to be formed into the ink droplet amount by using the estimated ink droplet amount at the time of receiving the signal for starting the total amount regulation, in a case where the tone value is converted into the ink droplet amount; and
performing the total amount regulation to regulate a total ink droplet amount to be used for image formation to a preset value, the total ink droplet amount being the ink droplet converted from the tone value.

15. A non-transitory recording medium storing a plurality of instructions which, when executed by one or more processors, causes the one or more processors to perform an information processing method comprising:
estimating, in response to receiving a signal for starting total amount regulation, an ink droplet amount for the time of receiving the signal for starting the total amount regulation, based on a condition that affects a change in the ink droplet amount;
converting a tone value of an image to be formed into the ink droplet amount by using the estimated ink droplet amount at the time of receiving the signal for starting the total amount regulation, in a case where the tone value is converted into the ink droplet amount; and
performing the total amount regulation to regulate a total ink droplet amount to be used for image formation to a preset value, the total ink droplet amount being the ink droplet converted from the tone value.
